(19) United States
(12) Patent Application Publication
(10) Pub. No.: US 2026/0210809 A1
(43) Pub. Date: Jul. 23, 2026

(54) DIAGNOSIS DEVICE

(71) Applicant: Fanuc Corporation, Minamitsuru-gun, Yamanashi (JP)

(72) Inventors: Liancheng HU, Minamitsuru-gun, Yamanashi (JP); Kazuhiro SATOU, Minamitsuru-gun, Yamanashi (JP)

(73) Assignee: Fanuc Corporation, Minamitsuru-gun, Yamanashi (JP)

(21) Appl. No.: 19/138,832

(22) PCT Filed: Jan. 24, 2023
(86) PCT No.: PCT/JP2023/002080

§ 371 Date: Jun. 13, 2025

(51) Int. Cl. G01M 99/00

(52) U.S. Cl. CPC G01M 99/005

(57) ABSTRACT

A diagnosis device includes a first acquisition unit that acquires first state data indicating the state of a diagnosis subject, a normal diagnosis unit that diagnoses an abnormality in the diagnosis subject on the basis of the first state data acquired by the first acquisition unit, a second acquisition unit that acquires second state data different from the first state data on the basis of a diagnosis result obtained by the normal diagnosis unit, and an emergency diagnosis unit that diagnoses a case of an abnormality that has occurred in the diagnosis subject on the basis of the second state data acquired by the second acquisition unit.

### CROSS REFERENCE TO RELATED APPLICATIONS

This is the U.S. National Phase application of PCT/JP2023/002080, filed Jan. 24, 2023, the disclosure of this application being incorporated herein by reference in its entirety for all purposes.

### FIELD OF THE INVENTION

This disclosure relates generally to a diagnosis device for diagnosing an abnormality.

### BACKGROUND OF THE INVENTION

There is a known technology to diagnose signs of abnormalities occurring in industrial machinery by collecting and analyzing various physical quantity data, such as currents and vibrations (e.g. Patent Literature 1).

### PATENT LITERATURE

[Patent Literature 1] Japanese Patent Laid-Open Publication No. 2020-12691

### BRIEF DESCRIPTION OF THE DRAWINGS

FIG. 1 shows an example of a system that includes a diagnosis device;

FIG. 2 is a block diagram showing an example of a hardware configuration of an industrial machine;

FIG. 3 is a block diagram showing an example of a hardware configuration of the diagnosis device;

FIG. 4 is a block diagram showing an example of functions of the diagnosis device;

FIG. 5 shows an example of a diagnosis result;

FIG. 6 shows an example of a display screen that displays information generated by a trigger generation unit;

FIG. 7 shows an example of a reception screen;

FIG. 8 shows an example of the diagnosis result displayed on a display device;

FIG. 9 is a flowchart showing a flow of processing conducted by the diagnosis device;

FIG. 10 is a block diagram showing another example of the functions of the diagnosis device;

FIG. 11 illustrates clustering;

FIG. 12 shows another example of the diagnosis result; and

FIG. 13 shows another example of the display screen that displays the information generated by the trigger generation unit.

### DETAILED DESCRIPTION OF EMBODIMENTS OF THE INVENTION

Collecting and analyzing a large amount of physical quantity data cause an increase in data management costs. For example, there is an increase in a load on analysis processing for the large amount of physical quantity data. In addition, the large amount of physical quantity data that does not make a large contribution to accuracy of an abnormality diagnosis is accumulated. On the other hand, when an amount of data collection is small, the abnormality diagnosis may not be performed with high accuracy. Thus, there is a need for a diagnosis device than can reduce the costs of the abnormality diagnosis and ensure the reliability of the abnormality diagnosis.

According to the disclosure, a diagnosis device according to the present disclosure includes: a first acquisition unit that acquires first state data that indicates a state of a diagnosis object; a normal diagnosis unit that diagnoses an abnormality in the diagnosis object based on the first state data acquired by the first acquisition unit; a second acquisition unit that acquires second state data that is different from the first state data based on a diagnosis result obtained by the normal diagnosis unit; and an emergency diagnosis unit that diagnoses a cause of the abnormality occurring in the diagnosis object based on the second state data acquired by the second acquisition unit.

A diagnosis device according to an embodiment of the present disclosure will now be described by referring to the accompanying drawings. In the description below, the same reference numerals will be used for components with the same or similar functions. These components may not be described repeatedly.

In this application, the phrase “based on XX” means “at least based on XX” and includes other elements in addition to XX. Furthermore, the phrase “based on XX” is not limited to a case where XX is used directly but also a case where computation and/or processing are carried out on XX. The word “XX” is an any element (e.g. arbitrary information).

### First Embodiment

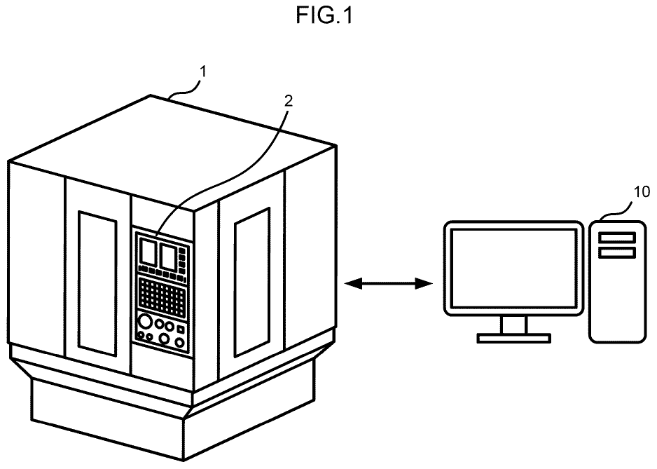

FIG. 1 shows an example of a system that includes a diagnosis device. This system includes an industrial machine 1 and a diagnosis device 10, by way of example. The industrial machine 1 operates on an industrial site. The industrial machine 1 is, for instance, a machine tool, an injection molding machine, a laser machine, a three-dimensional printer, and a robot. The industrial machine 1 is controlled by a controller 2.

The diagnosis device 10 is configured to diagnose an abnormality in the industrial machine 1. The diagnosis device 10 is connected wired or wirelessly to the controller 2. The diagnosis device 10 may be implemented in the controller 2.

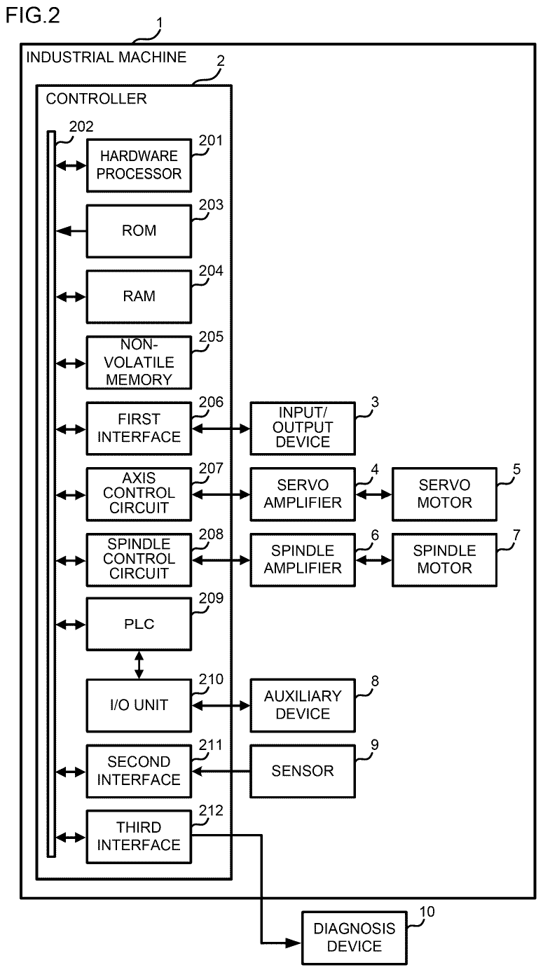

FIG. 2 is a block diagram showing an example of a hardware configuration of the industrial machine 1. The industrial machine 1 includes the controller 2, an input/output device 3, a servo amplifier 4, a servo motor 5, a spindle amplifier 6, a spindle motor 7, an auxiliary device 8, and a sensor 9.

The controller 2 is a numerical controller configured to control the industrial machine 1, by way of example. The controller 2 includes, for example, a hardware processor 201, a bus 202, a read only memory (ROM) 203, a random access memory (RAM) 204, and a non-volatile memory 205.

The hardware processor 201 is configured to control the entire controller 2 according to a system program. The hardware processor 201 reads a system program and others stored in the ROM 203 via the bus 202. The hardware processor 201 is, for example, a central processing unit (CPU) or electronic circuit.

The bus 202 is a communication channel configured to connect pieces of the hardware of the controller 2 to one another. The pieces of the hardware of the controller 2 exchange data with one another through the bus 202.

The ROM 203 is a storage device configured to store the system program and others. The ROM 203 is a computer-readable storage medium.

The RAM 204 is a storage device configured to temporarily store various data. The RAM 204 serves as a work area that is used by the hardware processor 201 to process the various data.

The non-volatile memory 205 is a storage device configured to retain data even when the controller 2 is turned off. The non-volatile memory 205 stores an operation program of the industrial machine 1, by way of example. The non-volatile memory 205 is a computer-readable storage medium. The non-volatile memory 205 consists of, for example, a battery-backed memory or a solid state drive (SSD).

The controller 2 further includes a first interface 206, an axis control circuit 207, a spindle control circuit 208, a programmable logic controller (PLC) 209, an I/O unit 210, a second interface 211, and a third interface 212.

The first interface 206 connects the bus 202 with the input/output device 3. For Example, the first interface 206 is configured to transmit the various data processed by the hardware processor 201 to the input/output device 3.

The input/output device 3 is configured to receive the various data through the first interface 206 and display the data on a display. Furthermore, upon the receipt of the various data thus input, the input/output device 3 transmits the various data via the first interface 206 to the hardware processor 201, for instance.

The input/output device 3 is, for example, a touch panel. In the case where the input/output device 3 is the touch panel, the input/output device 3 is a capacitance touch panel, by way of example. The touch panel is not limited to the capacitance type and may be a different type touch panel. The input/output device 3 is installed on an operator's panel, not shown, into which the controller 2 is housed.

The axis control circuit 207 is configured to control the servo motor 5. The axis control circuit 207 receives control commands from the hardware processor 201 and sends various commands for driving the servo motor 5 to the servo amplifier 4. The axis control circuit 207 sends, for instance, a torque command for controlling torque of the servo motor 5 to the servo amplifier 4.

The servo amplifier 4 is configured to supply a current to the servo motor 5 in response to the commands from the axis control circuit 207.

The servo motor 5 is driven by the current supplied from the servo amplifier 4. The servo motor 5 is provided to each control axis of the industrial machine 1. In a case where the industrial machine 1 is a machine tool having five axes, the servo motors 5 include, for example, an X-axis servo motor, a Y-axis servo motor, a Z-axis servo motor, an A-axis servo motor, and a C-axis servo motor. In this case, the axis control circuit 207 and the servo amplifier 4 are provided to each servo motor 5.

The servo motor 5 is coupled to a ball screw that drives a tool post, for instance. The servo motor 5 is driven to allow a structure of the industrial machine 1, such as the tool post, to move along a predetermined control axis.

The servo motor 5 incorporates an encoder, not shown, that is configured to detect a position of the control axis and a feedrate. Position feedback information and speed feedback information indicating the position of the control axis and the feedrate of the control axis, respectively, detected by the encoder are fed back to the axis control circuit 207. This allows the axis control circuit 207 to conduct feedback control on each control axis.

The spindle control circuit 208 is configured to control the spindle motor 7. The spindle control circuit 208 receives control commands from the hardware processor 201 and sends commands for driving the spindle motor 7 to the spindle amplifier 6. For example, the spindle control circuit 208 sends a spindle speed command for controlling a rotation speed of the spindle motor 7 to the spindle amplifier 6.

The spindle amplifier 6 is configured to supply a current to the spindle motor 7 in response to the commands from the spindle control circuit 208.

The spindle motor 7 is driven by the current supplied from the spindle amplifier 6. The spindle motor 7 is coupled to a spindle to rotate it.

The PLC 209 is configured to execute a ladder program to control the auxiliary device 8. The PLC 209 sends commands to the auxiliary device 8 through the I/O unit 210.

The I/O unit 210 is an interface configured to connect the PLC 209 with the auxiliary device 8. The I/O unit 210 transmits the commands from the PLC 209 to the auxiliary device 8.

The auxiliary device 8 is installed on the industrial machine 1 and is configured to perform auxiliary operations in the industrial machine 1. The auxiliary device 8 works based on the commands received from the I/O unit 210. The auxiliary device 8 may be disposed on the periphery of the industrial machine 1. The auxiliary device 8 is, for example, a turret, a coolant injection device, or a door open/close drive unit.

The second interface 211 connects the bus 202 with the sensor 9. For example, the second interface 211 is configured to transmit information acquired by the sensor 9 to the hardware processor 201 via the bus 202.

The sensor 9 is provided to each component of the industrial machine 1 to detect various physical quantities. The sensor 9 is a temperature sensor, an acceleration sensor, an ammeter, and a liquid scale, by way of example.

The third interface 212 connects the bus 202 with the diagnosis device 10. For example, the third interface 212 is configured to transmit information processed by the hardware processor 201 to the diagnosis device 10 via the bus 202.

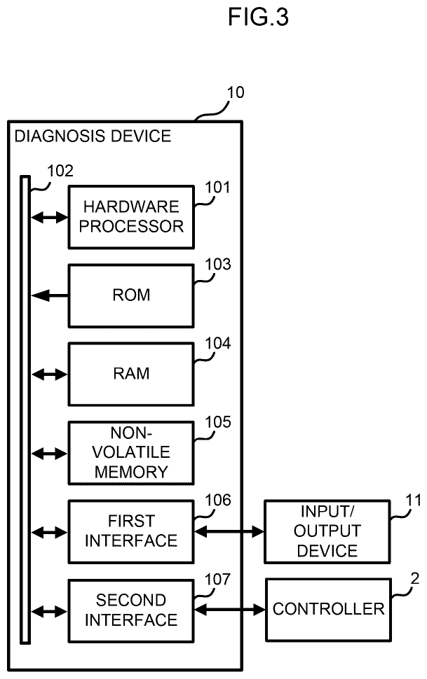

FIG. 3 is a block diagram showing an example of a hardware configuration of the diagnosis device 10. The diagnosis device 10 includes, for example, a hardware processor 101, a bus 102, an ROM 103, an RAM 104, a non-volatile memory 105, a first interface 106, and a second interface 107.

The hardware processor 101 is configured to control the entire diagnosis device 10 according to a system program. The hardware processor 101 reads a system program and others stored in the ROM 103 via the bus 102. The hardware processor 101 is, for instance, a CPU or electronic circuit.

The bus 102 is a communication channel configured to connect pieces of the hardware of the diagnosis device 10 with one another. The pieces of the hardware of the diagnosis device 10 exchange data with one another through the bus 102.

The ROM 103 is a storage device configured to store the system program and others. The ROM 103 is a computer-readable storage medium.

The RAM 104 is a storage device configured to temporarily store various data. The RAM 104 serves as a work area that is used by the hardware processor 101 to process the various data.

The non-volatile memory 105 is a storage device configured to retain data even when the diagnosis device 10 is turned off. The non-volatile memory 105 is a computer-readable storage medium. The non-volatile memory 105 consists of, for example, a battery-backed memory or an SSD.

The first interface 106 connects the bus 102 with an input/output device 11. For Example, the first interface 106 is configured to transmit various data processed by the hardware processor 101 to the input/output device 11.

The input/output device 11 is configured to receive the various data through the first interface 106 and display the data on a display. Furthermore, upon the receipt of the various data thus input, the input/output device 11 transmits the various data via the first interface 106 to, for instance, the hardware processor 101. The input/output device 11 is a touch panel, by way of example.

The second interface 107 connects the bus 102 with the controller 2. For example, the second interface 107 is configured to transmit the various data received from the controller 2 to the hardware processor 101.

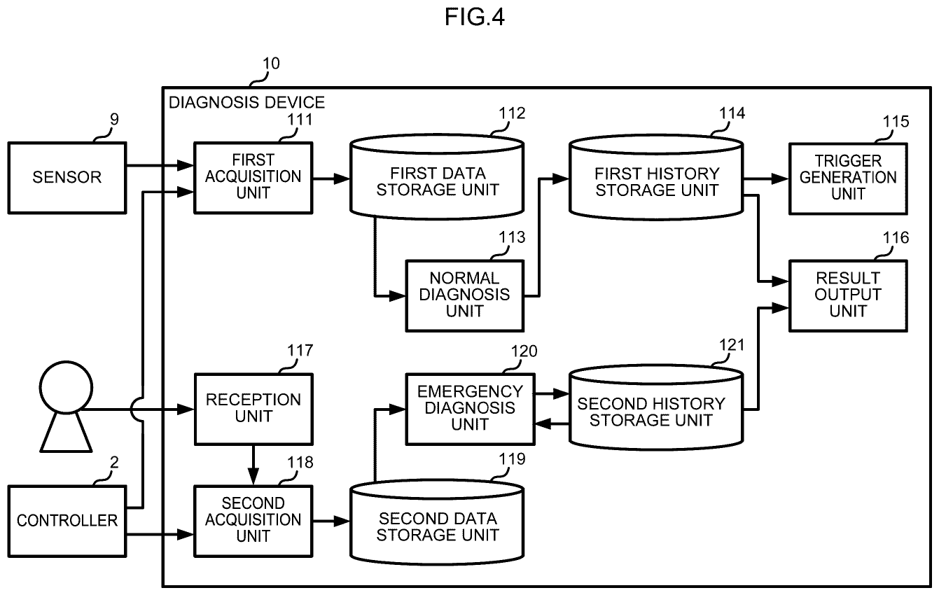

FIG. 4 is a block diagram showing an example of the functions of the diagnosis device 10. For example, the diagnosis device 10 includes a first acquisition unit 111, a first data storage unit 112, a normal diagnosis unit 113, a first history storage unit 114, a trigger generation unit 115, a result output unit 116, a reception unit 117, a second acquisition unit 118, a second data storage unit 119, an emergency diagnosis unit 120, and a second history storage unit 121.

The first acquisition unit 111, the normal diagnosis unit 113, the trigger generation unit 115, the result output unit 116, the reception unit 117, the second acquisition unit 118, and the emergency diagnosis unit 120 are implemented by arithmetic operations by the hardware processor 101 using the system program stored in the ROM 103 and the various data stored in the non-volatile memory 105, for instance.

For example, the first data storage unit 112, the first history storage unit 114, the second data storage unit 119, and the second history storage unit 121 are implemented by storing various information in the RAM 104 or the non-volatile memory 105.

The first acquisition unit 111 is configured to acquire first state data that indicates a state of a diagnosis object. For example, the diagnosis object includes devices and components that constitute the industrial machine 1. The devices and components constituting the industrial machine 1 are, for instance, a bearing, the servo motor 5, the spindle motor 7, a linear guide, a tool, and a spindle. The diagnosis object may be a compressor, a motor and the like of equipment installed in a factory.

The first acquisition unit 111 acquires the first state data at a predetermined cycle when the diagnosis object is in operation. The meaning of “when the diagnosis object is in operation” is, for example, a period of time during which the industrial machine 1 is in operation in accordance with an operation program.

The predetermine cycle is, for instance, a control cycle of the diagnosis device 10. The first acquisition unit 111 may change the cycle for acquiring the first state data. For example, the first acquisition unit 111 may acquire the first state data based on information that specifies a cycle accepted by the reception unit 117, about which will be described later. More specifically, the first acquisition unit 111 may acquire the first state data at a cycle specified by an operator.

The first state data includes, for example, a torque command and pieces of data that about current value, vibration, temperature, sound, elastic wave, speed and rotation speed. The data includes a signal. The first acquisition unit 111 acquires a torque command that specifies torque of the spindle motor 7, by way of example.

The first acquisition unit 111 acquires the first state data from the sensor 9 installed to the diagnosis object or from the controller 2.

The first data storage unit 112 is configured to store the first state data acquired by the first acquisition unit 111. The first data storage unit 112 stores the first state data in association with time information that indicates a time at which the first state data was acquired. That is to say, the first state data stored in the first data storage unit 112 is time-series data. In the case where the first acquisition unit 111 acquires the torque command that specifies the torque of the spindle motor 7, the data stored in the first data storage unit 112 is time-series data of values that specifies the torque of the spindle motor 7.

The normal diagnosis unit 113 is configured to diagnose an abnormality in the diagnosis object based on the first state data stored in the first data storage unit 112. That is to say, the normal diagnosis unit 113 diagnoses the abnormality in the diagnosis object based on the first state data acquired by the first acquisition unit 111.

For example, the normal diagnosis unit 113 diagnoses whether there is an abnormality in the diagnosis object. The normal diagnosis unit 113 diagnoses the abnormality in the diagnosis object by using a predefined abnormality detection model.

The abnormality detection model diagnoses the occurrence of the abnormality in the diagnosis object when the value in the first state data exceeds a predefined threshold value, by way of example. A plurality of threshold values may be set for the abnormality detection model.

For instance, for the abnormality detection model, a first threshold value, a second threshold value which is larger than the first threshold value, and a third threshold value which is larger than the second threshold value may be set. In this case, the abnormality detection model computes an abnormality level.

For example, in a case where the value in the first state data is equal to or lower than the first threshold value, the abnormality level is “0”. In this case there is no abnormality in the diagnosis object. In a case where the value in the first state data exceeds the first threshold value and is equal to or lower than the second threshold value, the abnormality level is “1”. In this case, there is an abnormality of low importance in the diagnosis object.

In a case where the value in the first state data exceeds the second threshold value and is equal to or lower than the third threshold value, the abnormality level is “2”. In this case, there is an abnormality of medium importance in the diagnosis object. In a case where the value in the first state data exceeds the third threshold value, the abnormality level is “3”. In this case, there is an abnormality of high importance in the diagnosis object.

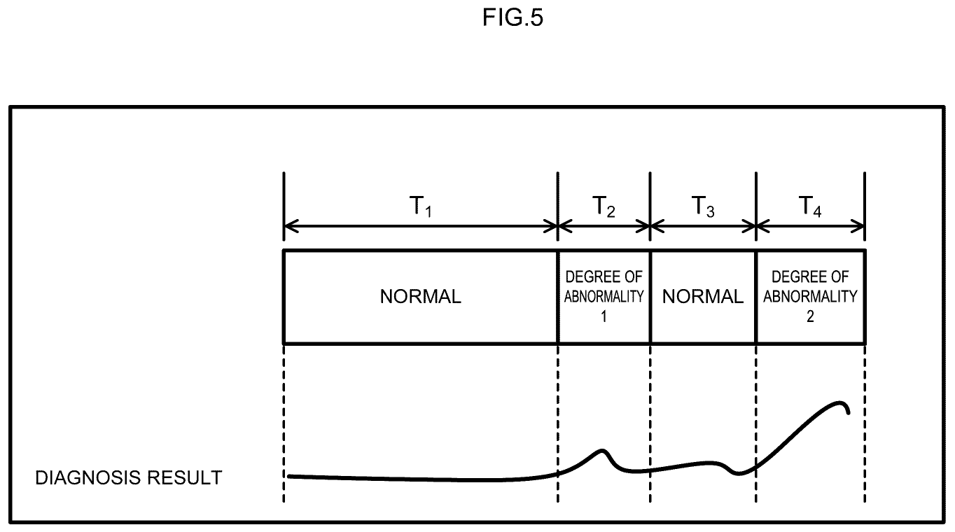

FIG. 5 shows an example of a diagnosis result obtained by the normal diagnosis unit 113. The value in the first state data is equal to or lower than the first threshold value during time periods T1 and T3. Thus, the normal diagnosis unit 113 determines that the diagnosis object is in operation normally.

The value in the first state data during a time period T2 exceeds the first threshold value and is equal to or lower than the second threshold value. In this case, the normal diagnosis unit 113 determines that there is the abnormality at the abnormality level “1” in the diagnosis object. Furthermore, the value in the first state data during a time period T4 exceeds the second threshold value. In this case, the normal diagnosis unit 113 determines that there is the abnormality at the abnormality level “2” in the diagnosis object.

The normal diagnosis unit 113 uses an abnormality detection model selected from a plurality of abnormality detection models for computing the abnormality level to diagnose the abnormality in the diagnosis object. More specifically, the abnormality detection model among the plurality of abnormality detection models is for computing the level of the abnormality occurring in the diagnosis object most properly.

For example, a difference between an abnormality level in a normal state and an abnormality level in an abnormal state computed by the abnormality detection model used by the normal diagnosis unit 113 is larger than differences between the abnormality level in the normal state and the abnormality level in the abnormal state computed by another abnormality detection models among the plurality of abnormality detection models.

The abnormality detection model is selected from the plurality of abnormality detection models according to the members constituting the diagnosis object, the configuration of the industrial machine 1 to which the diagnosis object is installed, the setting status of the industrial machine 1, an operation program for operating the industrial machine 1, and the environment in which the diagnosis object is installed.

The setting status of the industrial machine 1 means bearing pressurization, for instance. Furthermore, the setting status of the industrial machine 1 includes a setting status of parameters which is set to the controller 2. The environment in which the diagnosis object is installed means a temperature in the factory where the industrial machine 1 is installed. Now, the description about FIG. 4 will be made again.

The first history storage unit 114 is configured to store a diagnosis result obtained by the normal diagnosis unit 113. For example, the diagnosis result is information that indicates whether there is an abnormality in the diagnosis object. The diagnosis result may include information that indicates the abnormality level. The diagnosis result may include information that indicates a time of abnormality occurrence.

The trigger generation unit 115 is configured to generate a trigger based on the diagnosis result stored in the first history storage unit 114. The trigger generation unit 115 generates a trigger in response to storage of the diagnosis result indicating the abnormality occurrence in the diagnosis object in the first history storage unit 114.

The trigger is information or a signal that leads to the acquisition of second state data which is different from the first state data by the second acquisition unit 118. The information generated by the trigger generation unit 115 is to prompt the operator to execute a diagnosis operation, for instance. The information that prompts the execution of the diagnosis operation is, for example, displayed on the display device.

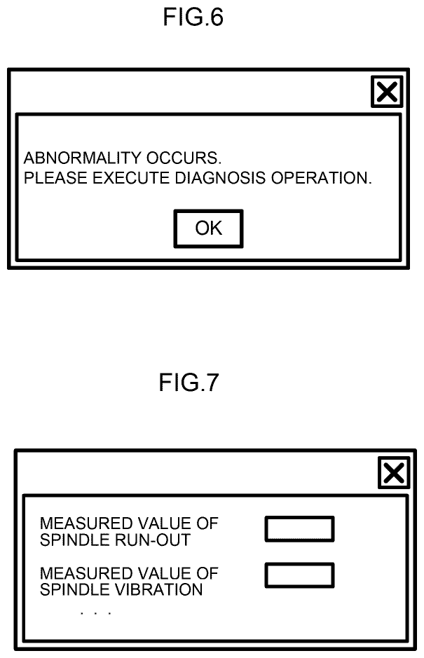

FIG. 6 shows an example of a display screen that displays the information generated by the trigger generation unit 115. For example, the display screen displays a text string “Abnormality occurs. Please execute a diagnosis operation.” In addition to that, an “OK” button is displayed below the text string.

When the information generated by the trigger generation unit 115 is displayed on the display screen, the operator executes the diagnosis operation. For example, in a case where the first state data is a torque command for the spindle motor 7 and the normal diagnosis unit 113 diagnoses that there is an abnormality in the diagnosis object, the operator executes the diagnosis operation on the spindle.

The diagnosis operation is, for instance, measurement of spindle run-out. For example, the spindle run-out is measured by measuring a distance between a tool holder attached to the spindle and an eddy-current displacement sensor while rotating the spindle. The spindle run-out may be measured by placing a dial gauge on the tool holder attached to the spindle.

The diagnosis operation may be measurement for vibrations in the diagnosis object. The vibrations in the diagnosis object are, for example, vibrations developed when the diagnosis object is subjected to a frequency sweep operation and vibrations developed when the diagnosis object is excited. That is to say, the second state data may be vibration data that is acquired when the diagnosis object is subjected to the frequency sweep operation or acquired when the diagnosis object is excited.

The frequency sweep operation is for vibrating a motor, such as the servo motor 5 and the spindle motor 7, by using an input signal entered in the motor. For example, the frequency sweep operation gradually increases the frequency of the input signal for the motor. The excitation of the diagnosis object means, for example, that an impact is given to the diagnosis object by an impulse hammer or similar.

The result output unit 116 is configured to output the diagnosis result obtained by the normal diagnosis unit 113. For example, in response to storage of the diagnosis result in the first history storage unit 114 that indicates that the diagnosis object is in the operation normally, the result output unit 116 displays a diagnosis result indicating that the diagnosis object is in operation normally on a display device, for instance.

On the other hand, in response to storage of the diagnosis result in the first history storage unit 114 that indicates the occurrence of an abnormality in the diagnosis object, the result output unit 116 displays a diagnosis result indicating that there is the abnormality in the diagnosis object on the display device, for instance. The display device is the input/output device 11, for example. The result output unit 116 may output an electronic file in which the diagnosis result is recorded to, for instance, an external server, not shown. Now, the description about FIG. 4 will be made again.

The reception unit 117 is configured to accept the result of the diagnosis operation input by the operator. For example, the reception unit 117 displays a reception screen on the display device and accepts the input of the result of the diagnosis operation from the reception screen.

FIG. 7 shows an example of the reception screen. For example, the reception screen includes an area for receiving an input of a measured value of the spindle run-out, and an area for receiving an input of a measured value of the vibration in the spindle. Upon input of the measured values in these areas by the operator, the reception unit 117 accepts the result of the diagnosis operation. The description about FIG. 4 will now be made again.

The second acquisition unit 118 is configured to acquire the second state data that is different from the first state data based on the diagnosis result obtained by the normal diagnosis unit 113. For example, the second state data is information that indicates the result of the diagnosis operation that is input by the operator and accepted by the reception unit 117. In other words, when a trigger is generated based on the diagnosis result obtained by the normal diagnosis unit 113, the second acquisition unit 118 acquires information that indicates the result of the diagnosis operation conducted based on the trigger.

The second acquisition unit 118 acquires, for example, information that indicates the spindle run-out and information that indicates the vibration in the spindle. The second state data is not limited to the information accepted by the reception unit 117. The second state data may be pieces of data detected by the sensor 9. In this case, the second acquisition unit 118 starts acquiring the second state data at a predetermined cycle in response to the generation of the trigger by the trigger generation unit 115.

The pieces of data detected by the sensor 9 are, for instance, the torque command as well as various data about the current value, the vibration, the temperature, the sound, the elastic wave, the speed, and the rotation speed. The pieces of data include signals. The second state data may be acquired from the controller 2.

The second acquisition unit 118 may acquire information indicating electric resistance between a workpiece and a tool during cutting from the sensor 9, by way of example. It is known that as wear in the tool progresses, the electric resistance between the tool and the workpiece decreases. Since the second acquisition unit 118 acquires the information indicating the electric resistance between the tool and the workpiece, the emergency diagnosis unit 120, about which will be described later, can diagnose the wear in the tool based on the information indicating the electric resistance.

In addition to that, the second acquisition unit 118 may acquire the temperature of the bearing from the sensor 9, for example. It is known that when the bearing is damaged, the temperature of the bearing rises. Since the second acquisition unit 118 acquires the temperature of the bearing, the after-mentioned emergency diagnosis unit 120 can diagnose the damage to the bearing based on this temperature.

The second data storage unit 119 is configured to store the second state data acquired by the second acquisition unit 118. That is to say, the second data storage unit 119 stores the information accepted by the reception unit 117.

The second data storage unit 119 also stores the data detected by the sensor 9. When the second state data is the data detected by the sensor 9, the second data storage unit 119 stores the second state data in association with time information that indicates a time at which the second state data was acquired. In other words, the second state data stored in the second data storage unit 119 may be time-series data.

The emergency diagnosis unit 120 is configured to diagnose the cause of the abnormality occurring in the diagnosis object based on the second state data acquired by the second acquisition unit 118. In other words, the emergency diagnosis unit 120 diagnoses the cause of the abnormality occurring in the diagnosis object based on the second state data stored in the second data storage 119.

The emergency diagnosis unit 120 uses a predefined diagnosis model to diagnose the cause of the abnormality occurring in the diagnosis object. The cause of the abnormality refers to a place where the abnormality occurs and a state of abnormality, for instance.

For example, the emergency diagnosis unit 120 diagnoses as the cause of the abnormality that there is abnormality in the bearing, the motor, or the tool. The emergency diagnosis unit 120 also diagnoses, for instance, that there is wear, losses, or breaks. Furthermore, the emergency diagnosis unit 120 diagnoses that a component is at the end of its service life.

The diagnosis model shows a correlation between the second state data and the cause of the abnormality occurring in the diagnosis object, by way of example. The diagnosis model is created by performing machine learning by using the second state data and the information indicating the cause of the abnormality as training data.

For example, in a case where the measured value of the spindle run-out is equal to or more than α1 [mm] and less than α2 [mm] and a vibration appears in a specific frequency band as the spindle rotates, the diagnosis model outputs information indicating that damage is done to the bearing of the spindle. In other words, the emergency diagnosis unit 120 diagnoses that damage is done to the bearing of the spindle. In here, the vibration in the specific frequency band includes, for instance, a sideband wave of a wave indicating a rotational frequency of the spindle.

In a case where the measured value of the spindle run-out is equal to or more than α2 [mm] and the vibration appears in the specific frequency band as the spindle rotates, for example, the diagnosis model outputs information indicating that a foreign matter is caught between the spindle and the tool holder. In other words, the emergency diagnosis unit 120 diagnoses that the foreign matter is caught between the spindle and the tool holder. In here, the vibration in the specific frequency band represents the rotational frequency of the spindle, by way of example.

In a case where the second state data include multiple types of data, the emergency diagnosis unit 120 may diagnose the cause of the abnormality occurring in the diagnosis object based on the correlation between the multiple types of data. For example, in a case where there is a correlation between a rotation speed of the servo motor 5 in a normal state and a frequency component of a vibration in the servo motor 5 in the normal state, a correlation between a rotation speed of the servo motor 5 in an abnormal state and the frequency component of the vibration differs from the correlation in the normal state. Thus, the emergency diagnosis unit 120 diagnoses the cause of the abnormality in the diagnosis object based on the fact that the correlation between the rotation speed of the servo motor 5 and the frequency component of the vibration is different from the correlation between the rotation speed of the servo motor 5 in the normal state and the frequency component of the vibration.

The second history storage unit 121 is configured to store a history of cause information that indicates the cause of the abnormality in the diagnosis object diagnosed by the emergency diagnosis unit 120. The cause information is stored in association with the second state data and the time of acquisition of the second state data, respectively.

The emergency diagnosis unit 120 may diagnose the cause of the abnormality occurring in the diagnosis object based on the cause information stored in the second history storage unit 121. More specifically, the emergency diagnosis unit 120 determines whether past second state data stored in the second history storage unit 121 matches the second state data stored in the second data storage unit 119. When these pieces of data match each other, the emergency diagnosis unit 120 diagnoses that there is the abnormality in the diagnosis object that is indicated by the cause information stored in association with the second state data in the second history storage unit 121.

The past second state data stored in the second history storage unit 121 does not necessarily closely match the second state data stored in the second data storage unit 119. That is to say, in a case where the past second state data is similar to newly acquired second state data to a predefined extent, the emergency diagnosis unit 120 may diagnose that there is the abnormality in the diagnosis object that is indicated by the cause information stored in association with the second state data.

The result output unit 116 is configured to output the diagnosis result obtained by the emergency diagnosis unit 120. The result output unit 116 displays the diagnosis result on the display device, for instance, in response to the storage of the diagnosis result showing the cause of the abnormality in the second history storage unit 121.

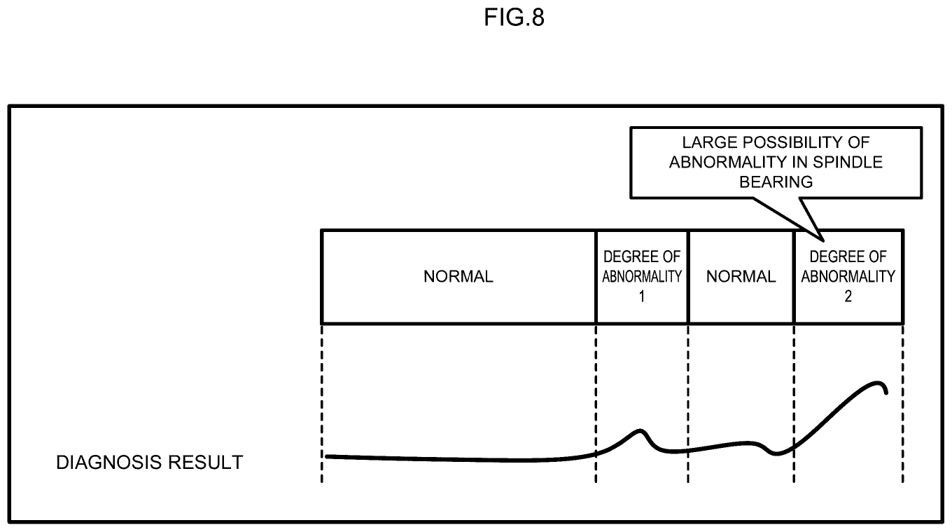

FIG. 8 shows an example of the diagnosis result displayed on the display device. For example, in response to the storage of a diagnosis result showing the occurrence of an abnormality in the bearing of the spindle in the second history storage unit 121, the result output unit 116 displays on the display device a text string showing the diagnosis result, “There is a high possibility of abnormality in spindle bearing.” The result output unit 116 may display the diagnosis result obtained by the emergency diagnosis unit 120 on the display device together with the diagnosis result obtained by the normal diagnosis unit 113. The result output unit 116 may output an electronic file in which the diagnosis result is recorded to the external server, not shown, by way of example.

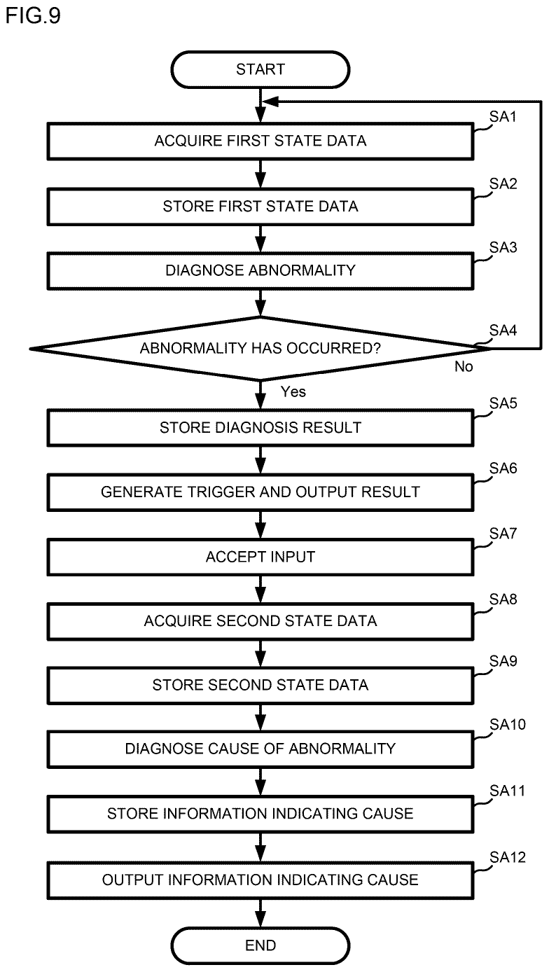

FIG. 9 is a flowchart showing an example of a flow of processing conducted by the diagnosis device 10. Firstly, in the diagnosis device 1, the first acquisition unit 111 acquires the first state data (step SA1).

Then, the first data storage unit 112 stores the first state data acquired by the first acquisition unit 111 (step SA2).

Subsequently, the normal diagnosis unit 113 diagnoses an abnormality in the diagnosis object based on the first state data stored in the first data storage unit 112 (step SA3).

When there is no abnormality in the diagnosis object (No in step SA4), the first acquisition unit 111 continues the acquisition of the first state data (step SA1).

When there is an abnormality in the diagnosis object (Yes in step SA4), the first history storage unit 114 stores the diagnosis result obtained by the emergency diagnosis unit 113 (step SA5).

When the diagnosis result is stored in the first history storage unit 114, the trigger generation unit 115 generates a trigger and the result output unit 116 outputs the diagnosis result (step SA6).

When the trigger generation unit 115 generates the trigger, the operator executes a diagnosis operation, and the reception unit 117 accepts the input of a result of the diagnosis operation (step SA7).

In the next step, the second acquisition unit 118 acquires second state data (step SA8). In here, the second state data is information that indicates the result of the diagnosis operation accepted by the reception unit 117.

Then, the second data storage unit 119 stores the second state data acquired by the second acquisition unit 118 (step SA9).

After that, the emergency diagnosis unit 120 diagnoses the cause of the abnormality occurring in the diagnosis object based on the second state data stored in the second data storage unit 119 (step SA10).

Subsequently, the second history storage unit 121 stores the information indicating the cause of the abnormality diagnosed by the emergency diagnosis unit (step SA11).

Lastly, the result output unit 116 outputs the information indicating the cause of the abnormality stored in the second history storage unit 121 (step SA12), and the processing is terminated.

### Second Embodiment

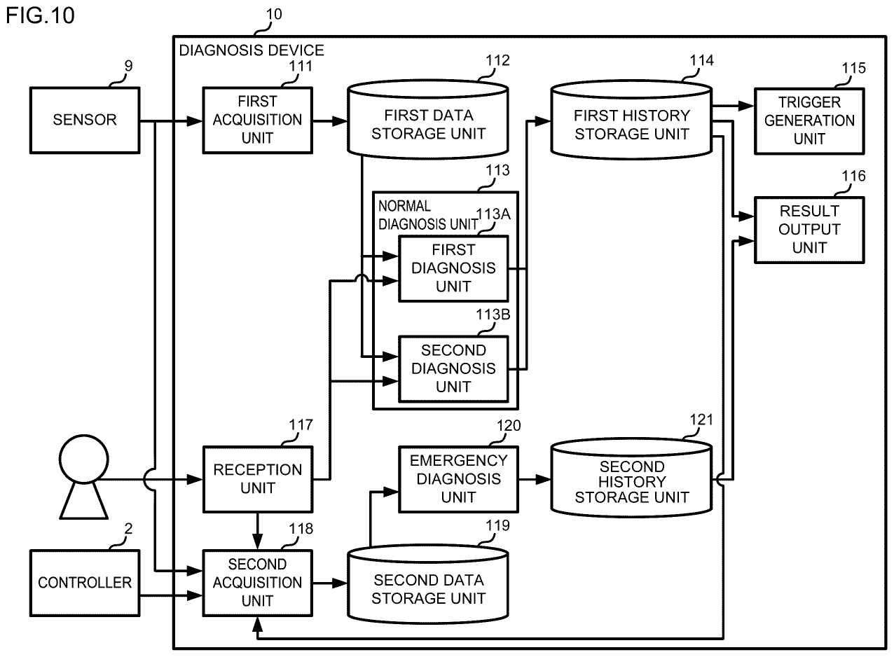

FIG. 10 is a block diagram showing an example of the functions of the diagnosis device 10 according to a second embodiment. A description will be made below principally about the functions different from those according to the first embodiment, and a description about the same functions as those of the first embodiment may be omitted.

The diagnosis device 10 of the present embodiment differs from the diagnosis device 10 of the first embodiment in that the normal diagnosis unit 113 includes a first diagnosis unit 113A and a second diagnosis unit 113B.

The normal diagnosis unit 113 includes the first diagnosis unit 113A and the second diagnosis unit 113B. The first diagnosis unit 113A is configured to diagnose whether there is an abnormality in a diagnosis object based on first state data. The first diagnosis unit 113A uses a predefined abnormality detection model to diagnose whether there is the abnormality in the diagnosis object.

The abnormality detection model diagnoses the occurrence of the abnormality when the value of the first state data exceeds a preset threshold value, by way of example.

The second diagnosis unit 113B is configured to diagnose the type of the abnormality occurring in the diagnosis object based on the first state data. The second diagnosis unit 113B conducts clustering on the first state data to diagnose the type of the abnormality.

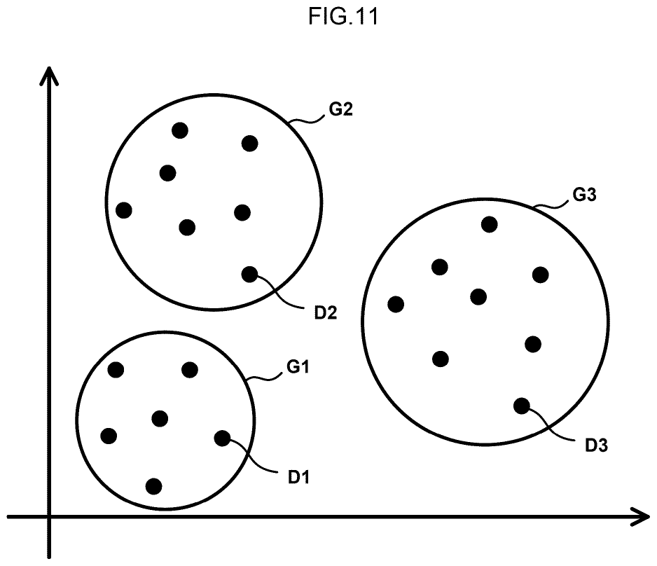

FIG. 11 illustrates the clustering. Black circles shown in FIG. 11 denote analysis data obtained by analyzing the first state data. For example, the analysis data is multidimensional data that is obtained by subjecting the first state data to frequency analysis.

The second diagnosis unit 113B uses a clustering technique, such as k-means clustering, to group the analysis data. For example, the second diagnosis unit 113B groups the analysis data into a first group G1, a second group G2, and a third group G3.

Each group is labelled with information indicating the abnormality. For instance, in a case where a group includes analysis data of the first state data that is acquired when there is a known abnormality, it is estimated that this group is a cluster of analysis data of the first state data acquired when the known abnormality occurs. That is to say, this group is labelled with information indicating the known abnormality.

It is assumed that analysis data D1 is derived by analyzing the first state data acquired when the diagnosis object is operating in a normal state. In this case, it is estimated that other analysis data included in the first group are derived by analyzing the first state data acquired when the diagnosis object is operating in the normal state. Thus, the first group is labelled with information indicating that the diagnosis object is in the normal state.

It is assumed that analysis data D2 is derived by analyzing the first state data acquired when the diagnosis object is operating in a worn state. In this case, it is estimated that other analysis data included in the second group are derived by analyzing the first state data acquired when the diagnosis object is operating in the worn state. Thus, the second group is labelled with information indicating that the diagnosis object is worn out.

It is assumed that the analysis data D3 is derived by analyzing the first state data acquired when the diagnosis object is operating in a damaged state. In this case, it is estimated that other analysis data included in the third group are derived by analyzing the first state data acquired when the diagnosis object is operating in the damaged state. Thus, the third group is labelled with information indicating that the diagnosis object is damaged.

The second diagnosis unit 113B determines which group the analysis data derived by analyzing the first state data belongs to. For example, when the analysis data belongs to the first group G1, the second analysis unit 113B diagnoses that the diagnosis object is operating normally.

When the analysis data belongs to the second group G2, the second diagnosis unit 113B diagnoses that the diagnosis object is operating in the worn state. That is to say, the second diagnosis unit 113B diagnoses that the type of the abnormality occurring in the diagnosis object is wear.

When the analysis data belongs to the third group G3, the second diagnosis unit 113B diagnoses that the diagnosis object is operating in the damaged state. That is to say, the second diagnosis unit 113B diagnoses that the abnormality occurring in the diagnosis object is damage.

When the analysis data does not belong to any group, the second diagnosis unit 113B diagnoses that there is an unknown abnormality in the diagnosis object.

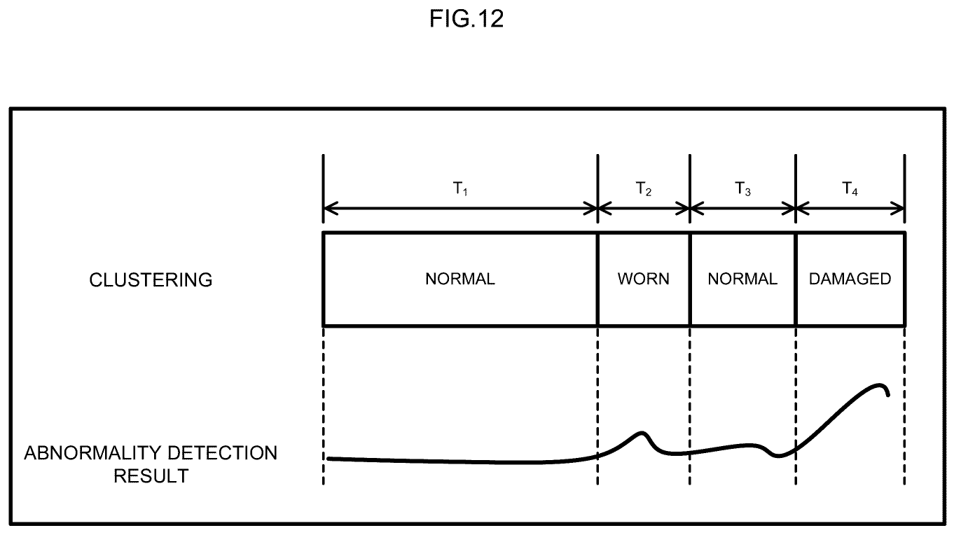

FIG. 12 shows an example of the diagnosis result obtained by the normal diagnosis unit 113. When the value of the first state data is equal to or lower than the predefined threshold value, it is determined that the diagnosis object is operating normally. Furthermore, in a case where the value of the first state data exceeds the predefined threshold value, the first diagnosis unit 113A diagnoses that there is an abnormality in the diagnosis object. In other words, the first diagnosis unit 113A diagnoses that there is the abnormality in the diagnosis object at the time period T2 and the time period T4.

The second diagnosis unit 113B diagnoses the type of the abnormality occurring in the diagnosis object based on the analysis data derived by analyzing the first state data. For instance, the second diagnosis unit 113B diagnoses that the diagnosis object is worn at the time period T2. In addition to that, the second diagnosis unit 113B diagnoses that the diagnosis object is damaged at the time period T4.

The first history storage unit 114 stores the diagnosis result obtained by the normal diagnosis unit 113. The trigger generation unit 115 generates a trigger based on the diagnosis result stored in the first history storage 114. The trigger generation unit 115 generates the trigger in response to the storage of the diagnosis result that indicates the abnormality occurrence in the diagnosis object in the first history storage unit 114.

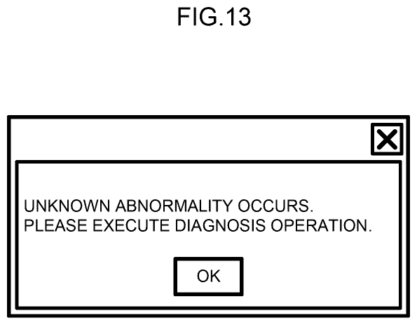

FIG. 13 shows an example of a display screen on which information generated by the trigger generation unit 115 is displayed. The display screen displays a text string “Unknown abnormality is occurring. Please execute diagnosis operation”, for instance. In addition to that, an “OK” button is displayed below the text string.

When the information generated by the trigger generation unit 115 is displayed on the display screen, the operator executes the diagnosis operation.

The result output unit 116 outputs the diagnosis result obtained by the normal diagnosis unit 113. In this embodiment, the functions of the reception unit 117, the second acquisition unit 118, the second data storage unit 119, the emergency diagnosis unit 120, and the second history storage unit 121 are the same as those in the first embodiment.

The reception unit 117 may accepts information that specifies the type of the first state data. In this case, the operator can specify the type of the first state data to be used for diagnosis in the normal diagnosis unit 113. Furthermore, the reception unit 117 may accepts information that specifies an abnormality detection model. In this case, a plurality of abnormality detection models can be stored in a storage unit, not shown, in advance. The first diagnosis unit 113A can diagnose the abnormality in the diagnosis object by using a specified abnormality detection model.

The second acquisition unit 118 may acquire the diagnosis result obtained by the normal diagnosis unit 113. In other words, the second acquisition unit 118 may acquire the diagnosis result stored in the first history storage unit 114. In this case, the emergency diagnosis unit 120 diagnoses the cause of the abnormality occurring in the diagnosis object based on the diagnosis result obtained by the normal diagnosis unit 113 and the second state data.

The second acquisition unit 118 may determine the type of the second state data to be acquired according to the diagnosis result obtained by the normal diagnosis unit 113. For example, the second acquisition unit 118 may acquire either information indicating spindle run-out or information indicating spindle vibration depending on whether the diagnosis result is the wear or damage.

As described above, the diagnosis device 10 includes the first acquisition unit 111 for acquiring the first state data indicating the state of the diagnosis object, the normal diagnosis unit 113 for diagnosing the abnormality in the diagnosis object based on the first state data acquired by the first acquisition unit 111, the second acquisition unit 118 for acquiring the second state data that differs from the first state data based on the diagnosis result obtained by the normal diagnosis unit 113, and the emergency diagnosis unit 120 for diagnosing the cause of the abnormality occurring in the diagnosis object based on the second state data acquired by the second acquisition unit 118.

In this way, the diagnosis device 10 can diagnose the diagnosis object based on the first state data that can be acquired at any time during the operation of the diagnosis object. That is to say, the diagnosis device 10 does not affect the operation of the diagnosis object when diagnosing the diagnosis object.

The second acquisition unit 118 acquires the second state data only when the normal diagnosis unit 113 determines that it is necessary. In other words, the second acquisition unit 118 acquires the second state data at an appropriate timing. Consequently, the diagnosis device 10 can reduce the costs of diagnosing the abnormality.

The diagnosis unit 10 diagnoses the diagnosis object based not only on the first state data but also on the second state data. Thus, the diagnosis device 10 can ensure the reliability of the diagnosis result.

Furthermore, the normal diagnosis unit 113 diagnoses the abnormality in the diagnosis object by using an abnormality detection model selected from a plurality of abnormality detection models for computing a degree of abnormality, and a difference between the degree of abnormality in a normal state and the degree of abnormality in an abnormal state computed by the abnormality detection model is larger than a difference between the degree of abnormality in the normal state and the degree of abnormality in the abnormal state computed by another normal detection model of the plurality of abnormality detection model. Thus, the normal diagnosis unit 113 can diagnose the abnormality in the diagnosis object appropriately.

The abnormality detection model is selected from the plurality of abnormality detection models according to the members constituting the diagnosis object, the configuration of the industrial machine 1 to which the diagnosis object is installed, the setting status of the industrial machine 1, the operation program for operating the industrial machine 1, and the environment in which the diagnosis object is installed. In this way, the abnormality detection model suitable for abnormality detection can be obtained. Consequently, the normal diagnosis unit 113 can diagnose the abnormality in the diagnosis object appropriately.

The diagnosis device 10 further includes the reception unit 117 that accepts at least either the information specifying the type of the first state data or the information specifying the type of the abnormality detection model. Thus, the diagnosis device 10 can diagnose the cause of the abnormality occurring in the diagnosis object appropriately based on the first state data and the abnormal detection model that are suitable for the diagnosis object.

The first acquisition unit 111 also changes the cycle of acquiring the first state data. It allows the operator to set the cycle according to the throughput of the diagnosis device 10.

The second state data is vibration data acquired when the diagnosis object is subjected to a frequency sweep operation or vibration data acquired when the diagnosis object is excited. Thus, the diagnosis device 10 can diagnose the cause of the abnormality occurring in the diagnosis object based on the vibration data.

The emergency diagnosis unit 120 also diagnoses the cause of the abnormality by analyzing a frequency component of the second state data. Thus, the emergency diagnosis unit 120 can diagnose the cause of the abnormality occurring in the diagnosis object with high accuracy.

Furthermore, the second state data include various data, and the emergency diagnosis unit 120 diagnoses the cause of the abnormality occurring in the diagnosis object based on a correlation between the various data. In this way, the emergency diagnosis unit 120 can diagnose the cause of the abnormality occurring in the diagnosis object with high accuracy.

The diagnosis device 10 further includes a history storage unit that records a history of the cause information indicating the cause of the abnormality diagnosed by the emergency diagnosis unit 120, and the emergency diagnosis unit 120 diagnoses the cause based on the cause information recorded in the history storage unit. In this way, the emergency diagnosis unit 120 diagnoses the cause of the abnormality occurring in the diagnosis object based on a past abnormality history. As a consequence, the diagnosis device 10 can reduce the processing load for the abnormality diagnosis. The history storage unit is the second history storage unit 121, for instance.

The normal diagnosis unit 113 includes the first diagnosis unit 113A and the second diagnosis unit 113B. The first diagnosis unit 113A diagnoses whether or not there is an abnormality in the diagnosis object, and the second diagnosis unit 113B diagnoses the type of the abnormality occurring in the diagnosis object. Thus, the emergency diagnosis unit 120 can select the second state data to be used for diagnosing the cause of the abnormality according to the type of the abnormality diagnosed by the second diagnosis unit 113B.

The present disclosure has been described in detail as above, but is not limited to the above-described individual embodiments. Thus, various additions, substitutions, modifications, partial deletions and so on may be made to these embodiments without departing from the gist of the disclosure or the spirit of the disclosure as derived from the contents described in the appended claims and their equivalents. Furthermore, these embodiments can be implemented by combining them.

In regard to the above-described embodiments, supplementary notes will be disclosed as below.

### Supplementary Note (1)

A diagnosis device includes a first acquisition unit that acquires first state data that indicates a state of a diagnosis object, a normal diagnosis unit that diagnoses an abnormality in the diagnosis object based on the first state data acquired by the first acquisition unit, a second acquisition unit that acquires second state data that is different from the first state data based on a diagnosis result obtained by the normal diagnosis unit, and an emergency diagnosis unit that diagnoses a cause of the abnormality occurring in the diagnosis object based on the second state data acquired by the second acquisition unit.

### Supplementary Note (2)

The diagnosis device according to Supplementary Note (1), in which the normal diagnosis unit diagnoses the abnormality in the diagnosis object by using an abnormality detection model that is selected from a plurality of abnormality detection models for calculating a degree of the abnormality, and a difference between a degree of abnormality in a normal state and a degree of abnormality in an abnormal state that are calculated by the abnormality detection model is larger than a difference between the degree of abnormality in the normal state and the degree of abnormality in the abnormal state that are calculated by another abnormality detection model among the plurality of abnormality detection models.

### Supplementary Note (3)

The diagnosis device according to Supplementary Note (2), in which the abnormality detection model is selected from the plurality of abnormality detection models according to members constituting the diagnosis object, a configuration of an industrial machine to which the diagnosis object is installed, a setting status of the industrial machine, an operation program for operating the industrial machine, and an environment in which the diagnosis object is installed.

### Supplementary Note (4)

The diagnosis device according to Supplementary Note (2) or (3) further includes a reception unit that accepts at least either information that specifies the type of the first state data or information that specifies the type of the abnormality detection model.

### Supplementary Note (5)

The diagnosis device according to any of Supplementary Notes (1) to (4), in which the first acquisition unit changes a cycle of acquiring the first state data.

### Supplementary Note (6)

The diagnosis device according to any of Supplementary Notes (1) to (5), in which the second state data is vibration data acquired when the diagnosis object is subjected to a frequency sweep operation or vibration data acquired when the diagnosis object is excited.

### Supplementary Note (7)

The diagnosis device according to any of Supplementary Notes (1) to (6), in which the emergency diagnosis unit analyzes a frequency component of the second state data to diagnose the cause of the abnormality.

### Supplementary Note (8)

The diagnosis device according to any of Supplementary Notes (1) to (7), in which the second state data include various data, and the emergency diagnosis unit diagnoses the cause of the abnormality occurring in the diagnosis object based on a correlation between the various data.

### Supplementary Note (9)

The diagnosis device according to any of Supplementary Notes (1) to (8) further includes a history storage unit that records a history of cause information that indicates the cause of the abnormality diagnosed by the emergency diagnosis unit, in which the emergency diagnosis unit diagnoses the cause based on the cause information recorded in the history storage unit.

### Supplementary Note (10)

The diagnosis device according to any of Supplementary Notes (1) to (9), in which the normal diagnosis unit includes a first diagnosis unit and a second diagnosis unit, in which the first diagnosis unit diagnoses whether there is an abnormality in the diagnosis object, and the second diagnosis unit diagnoses the type of the abnormality occurring in the diagnosis object.

1.A diagnosis device, comprising:
a first acquisition unit that acquires first state data that indicates a state of a diagnosis object;
a normal diagnosis unit that diagnoses an abnormality in the diagnosis object based on the first state data acquired by the first acquisition unit;
a second acquisition unit that acquires second state data that is different from the first state data based on a diagnosis result obtained by the normal diagnosis unit; and
an emergency diagnosis unit that diagnoses a cause of the abnormality occurring in the diagnosis object based on the second state data acquired by the second acquisition unit.

2. The diagnosis device according to claim 1, wherein the normal diagnosis unit diagnoses the abnormality in the diagnosis object by using an abnormality detection model that is selected from a plurality of abnormality detection models for calculating a degree of abnormality, and
a difference between a degree of abnormality in a normal state and a degree of abnormality in an abnormal state that are calculated by the abnormality detection model is larger than a difference between the degree of abnormality in the normal state and the degree of abnormality in the abnormal state that are calculated by another abnormality detection models among the plurality of abnormality detection models.

3. The diagnosis device according to claim 2, wherein the abnormality detection model is selected from the plurality of abnormality detection models according to members that constitute the diagnosis object, a configuration of an industrial machine to which the diagnosis object is installed, a setting status of the industrial machine, an operation program for operating the industrial machine, and an environment in which the diagnosis object is installed.

4. The diagnosis device according to claim 2, further comprising a reception unit that accepts at least either information that specifies the type of the first state data or information that specifies the type of the abnormality detection model.

5. The diagnosis device according to claim 1, wherein the first acquisition unit changes a cycle of acquiring the first state data.

6. The diagnosis device according to claim 1, wherein the second state data is vibration data acquired when the diagnosis object is subjected to a frequency sweep operation or vibration data acquired when the diagnosis object is excited.

7. The diagnosis device according to claim 1, wherein the emergency diagnosis unit analyzes a frequency component of the second state data to diagnose the cause of the abnormality.

8. The diagnosis device according to claim 1, wherein the second state data include various data, and
based on a correlation between the various data, the emergency diagnosis unit diagnoses the cause of the abnormality occurring in the diagnosis object.

9. The diagnosis device according to claim 1, further comprising a history storage unit that records a history of cause information that indicates the cause of the abnormality diagnosed by the emergency diagnosis unit, wherein
the emergency diagnosis unit diagnoses the cause based on the cause information recorded in the history storage unit.

10. The diagnosis device according to claim 1, wherein the normal diagnosis unit includes a first diagnosis unit and a second diagnosis unit,
the first diagnosis unit diagnosing whether there is the abnormality in the diagnosis object,
the second diagnosis unit diagnosing a type of the abnormality occurring in the diagnosis object.
